(19) United States
(12) Patent Application Publication
(10) Pub. No.: US 2018/0254664 A1
(43) Pub. Date: Sep. 6, 2018

(54) POWER SUPPLY APPARATUS, ELECTRONIC DEVICE, CONTROL METHOD THEREOF, AND POWER SUPPLY SYSTEM

(71) Applicant: CANON KABUSHIKI KAISHA, Tokyo (JP)

(72) Inventor: Akihiro Tanabe, Tokyo (JP)

(21) Appl. No.: 15/903,388

(22) Filed: Feb. 23, 2018

(30) Foreign Application Priority Data
Mar. 3, 2017 (JP) 2017-040915

(51) Int. Cl. H02J 50/10; H02J 50/60; H04B 5/00

(52) U.S. Cl. CPC H02J 50/10; H04B 5/0037; H02J 50/60

(57) ABSTRACT

A power supply apparatus includes a communication unit which performs power transmission and transmission/reception of information in a non-contact manner, a detector which detects intrusion of an object in a communication range of the communication unit, an acquisition unit which acquires information indicating a size of an electronic device from the electronic device via the communication unit, a determiner which determines a detection range in which intrusion of an object is detected by the detector, based on the acquired information, and a controller which supplies power to the electronic device via the communication unit. In addition, the controller controls power supply to the electronic device based on detection of intrusion of an object in the detection range performed by the detector, during power supply to the electronic device.

### BACKGROUND OF THE INVENTION

### Field of the Invention

The present invention relates to a power supply apparatus that performs wireless power transmission, an electronic device that receives power, a control method thereof, and a power supply system.

### Description of the Related Art

In recent years, there are known power supply systems that include a communication apparatus that transmits power in a non-contact manner without connection using a connector and an electronic device that charges a battery mounted therein using power transmitted from the communication apparatus. Communication apparatuses in such non-contact power supply systems are known that supply power to electronic devices utilizing the electromagnetic field resonance phenomenon. When realizing a communication apparatus that transmits power in a non-contact manner, it is necessary to detect an extraneous object such as a metallic object or an unauthorized NFC (Near Field Communication) device, and appropriately control power supply. Japanese Patent Laid-Open No. 2008-206231 suggests a method for detecting an extraneous object placed on a communication apparatus, using load change.

Regarding conventional communication apparatuses, a method for detecting an extraneous object using the load change of an electronic device is disclosed, but in a case where it is not possible to distinguish between a load change during charging, during load modulation communication, or the like and a load change due to the intrusion of an extraneous object, there is a possibility that an extraneous object will not be detected.

### SUMMARY OF THE INVENTION

The present invention provides a technique for detecting an extraneous object independently from a change in the load of a target electronic device to which power is to be supplied wirelessly, and controlling power supply so as to not influence the extraneous object.

According to an aspect of the invention, there is provided a power supply apparatus that wirelessly supplies power to an electronic device, comprising: a communication unit for performing power transmission and transmission/reception of information in a non-contact manner; a detector for detecting intrusion of an object in a communication range of the communication unit; an acquisition unit for acquiring information indicating a size of an electronic device from the electronic device via the communication unit; a determiner for determining a detection range in which intrusion of an object is detected by the detector, based on the acquired information; and a controller for supplying power to the electronic device via the communication unit, wherein the controller controls power supply to the electronic device based on detection of intrusion of an object in the detection range performed by the detector, during power supply to the electronic device.

According to the present invention, it is possible to accurately detect an extraneous object, and control power supply without influencing the extraneous object, by changing a condition for extraneous object detection performed by an extraneous object detector, based on the size of a target electronic device to which power is to be supplied wirelessly.

Further features of the present invention will become apparent from the following description of exemplary embodiments (with reference to the attached drawings).

### BRIEF DESCRIPTION OF THE DRAWINGS

FIG. 1 is a diagram showing an example of a system in embodiments of the present invention.

FIG. 2 is a block diagram showing an example of a wireless power transmission system in the embodiments.

FIG. 3A is a diagram showing the arrangement of an antenna and sensors of a communication apparatus in the embodiments.

FIG. 3B is a diagram showing the arrangement of an antenna and a housing exterior of an electronic device.

FIG. 4 is a flowchart showing processing of a communication apparatus in a first embodiment.

FIG. 5 is a flowchart showing processing of an electronic device in the first embodiment.

FIG. 6 is a flowchart showing processing of a communication apparatus in a second embodiment.

FIG. 7 is a flowchart showing case determination processing of the communication apparatus in the second embodiment.

FIG. 8 is a flowchart showing processing for determining a valid sensor of the communication apparatus in the second embodiment.

FIG. 9 is a diagram showing the relationship between a case determined by the communication apparatus and a sensor to be validated, in the second embodiment.

FIG. 10 is a flowchart showing processing of an electronic device in the second embodiment.

### DESCRIPTION OF THE EMBODIMENTS

Embodiments according to the present invention will be described below in detail with reference to the drawings.

### First Embodiment

### System Configuration Diagram

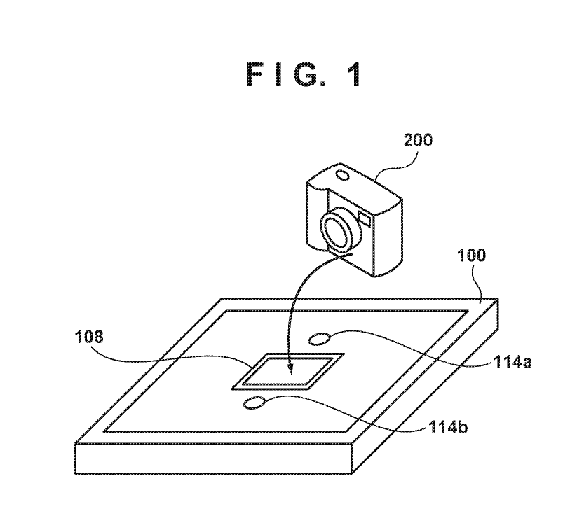

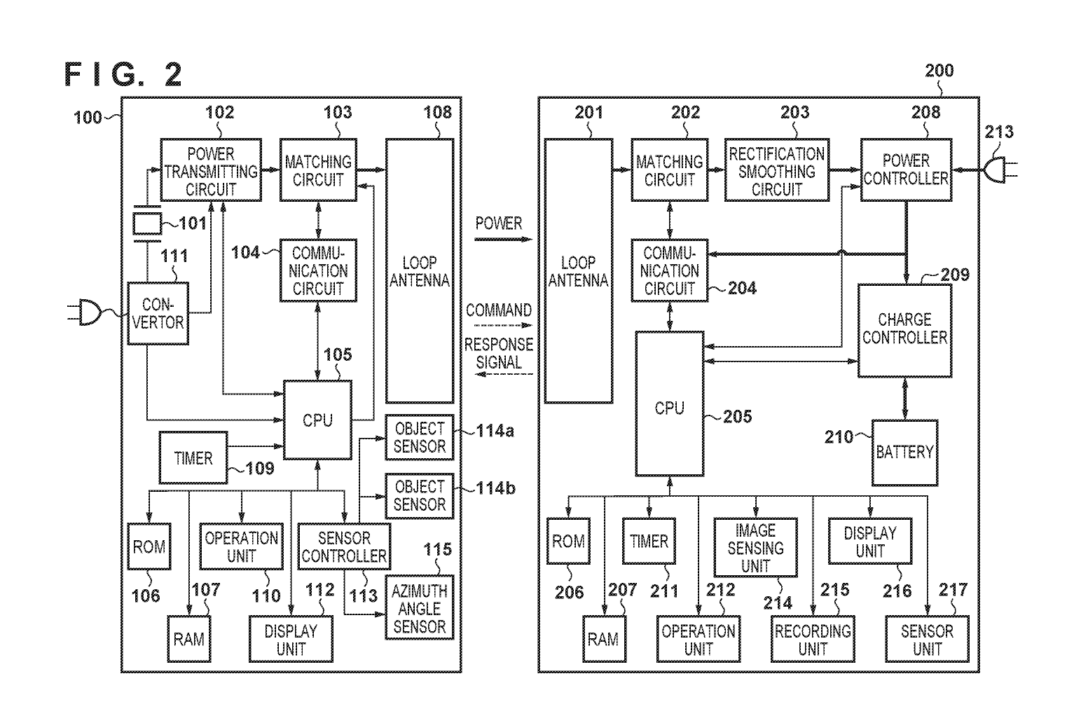

FIG. 1 shows a power supply system according to a first embodiment. This power supply system has a communication apparatus 100 that functions as a power supply apparatus that performs power supply in a non-contact manner (wireless power supply), and an electronic device 200 that functions as a receiver of the power. FIG. 2 shows a block configuration of the communication apparatus 100 and the electronic device 200.

When the electronic device 200 is placed on the placement stand of the communication apparatus 100 as shown in FIG. 1, the communication apparatus 100 determines whether or not only the electronic device 200 has been placed, by using a plurality of object sensors (in embodiment, two object sensors 114a and 114b) accommodated in the placement stand to detect whether or not there is an object. If it is determined that only the electronic device 200 has been placed on the placement stand, the communication apparatus 100 wirelessly communicates with and supplies power to the electronic device 200, via an antenna 108. In addition, if the distance between the communication apparatus 100 and the electronic device 200 is within a predetermined range, the electronic device 200 that has an antenna 201 wirelessly receives, via the antenna 201, power that has been output from the communication apparatus 100. Furthermore, the electronic device 200 charges a battery 210 mounted in the electronic device 200 using the power received from the communication apparatus 100 via the antenna 201.

In addition, if the distance between the communication apparatus 100 and the electronic device 200 is not within the predetermined range, the electronic device 200 cannot communicate with the communication apparatus 100 using the antenna 201. Note that the predetermined range is a range in which the electronic device 200 can perform communication using power supplied from the communication apparatus 100.

Note that the communication apparatus 100 can wirelessly supply power to a plurality of electronic devices in parallel.

As long as the electronic device 200 is an electronic device that has a communication unit for performing communication upon receiving power supplied from the battery 210, the electronic device 200 may be of any type. For example, the electronic device 200 may be an image capturing apparatus such as a smartphone, a digital still camera, a mobile phone with a camera, or a digital video camera, or may be a playback apparatus such as a player that plays back sound data and video data. Also, the electronic device 200 may be a moving apparatus such as an automobile that is driven with power supplied from the battery 210. As shown in FIG. 1, the electronic device 200 in the embodiments is a digital still camera, which is intended to be understood to be merely illustrative. Moreover, the electronic device 200 may be an electronic device that operates with power supplied from the communication apparatus 100 when the battery 210 is not mounted.

Next, a more detailed configuration of the communication apparatus 100 and the electronic device 200 will be described with reference to FIG. 2. The communication apparatus 100 has an oscillator 101, a power transmitting circuit 102, a matching circuit 103, a communication circuit 104, a CPU 105, a ROM 106, a RAM 107, the antenna 108, a timer 109, an operation unit 110, a converter 111, a display unit 112, a sensor controller 113, object sensors 114a and 114b, and an azimuth angle sensor 115.

The oscillator 101 is driven with power supplied from an AC power source (not illustrated) via the converter 111, and oscillates at a frequency that is used for controlling the power transmitting circuit 102. Note that the oscillator 101 uses a crystal oscillation element and the like.

The power transmitting circuit 102 generates power to be supplied to the electronic device 200 via the antenna 108, according to power supplied from the converter 111 and a frequency at which the oscillator 101 oscillates. The power transmitting circuit 102 has an FET and the like therein, and by controlling the current that flows between the source and drain terminals using the internal FET gate voltage according to the frequency at which the oscillator 101 oscillates, generates power to be supplied to the electronic device 200. Note that power generated by the power transmitting circuit 102 is supplied to the matching circuit 103. In addition, the power transmitting circuit 102 can also stop power from the FET by controlling the internal FET gate voltage.

In addition, power that is generated by the power transmitting circuit 102 includes first power and second power. The first power is power for performing communication to supply, to the electronic device 200, a request for the communication apparatus 100 to control the electronic device 200. The second power is power to be supplied to the electronic device 200 by the communication apparatus 100. For example, the first power is 0.1 to 1 W of power, and the second power is 2 to 10 W of power, where the first power is lower than the second power.

Note that, when the communication apparatus 100 supplies the first power to the electronic device 200, the communication apparatus 100 can transmit a request to the electronic device 200 via the antenna 108. However, when the communication apparatus 100 supplies the second power to the electronic device 200, the communication apparatus 100 cannot transmit a request to the electronic device 200 via the antenna 108.

The CPU 105 controls the power transmitting circuit 102 so as to switch the power to be supplied to the electronic device 200, to one of the first power, the second power, and power stop.

The matching circuit 103 is a resonance circuit that resonates with the antenna 108 at a resonance frequency f expressed by Expression 1 which is based on a capacitor capacitance, according to a frequency at which the oscillator 101 oscillates. Hereinafter, a frequency at which the communication apparatus 100 and a target device to which the communication apparatus 100 supplies power resonate with each other is referred to as the “resonance frequency f”. Expression 1 below indicates the resonance frequency f. L indicates the inductance of the antenna 108, and C indicates the capacitance of the matching circuit 103.

f=1/(2π×(L×C)^{1/2}) 1

Note that the resonance frequency f may be 50/60 Hz which is a commercial frequency, may be 10 to several hundreds kHz, or may be about 10 MHz.

In a state where the frequency at which the oscillator 101 oscillates is set to the resonance frequency f, power generated by the power transmitting circuit 102 is supplied to the antenna 108 via the matching circuit 103.

The communication circuit 104 modulates power generated by the power transmitting circuit 102, according to a predetermined protocol in order to transmit a request for controlling the electronic device 200, to the electronic device 200. The predetermined protocol is a communication protocol that complies with the ISO/IEC 18092 standard of RFID (Radio Frequency Identification), for example. In addition, the predetermined protocol may be a communication protocol that complies with an NFC (Near Field Communication) standard. Power generated by the power transmitting circuit 102 is converted by the communication circuit 104 into an analog signal as a request for performing communication with the electronic device 200, and is transmitted to the electronic device 200 via the antenna 108.

A pulse signal transmitted to the electronic device 200 is analyzed by the electronic device 200, and thus is detected as bit data including information “1” and information “0”. Note that the request includes identification information for identifying the destination, a request code indicating an operation that is instructed by the request, and the like. Also, the CPU 105 can transmit a request only to the electronic device 200 by controlling the communication circuit 104 so as to change the identification information included in the request. Moreover, the CPU 105 can also transmit a request to the electronic device 200 and a device other than the electronic device 200 by controlling the communication circuit 104 so as to change the identification information included in the request.

The communication circuit 104 converts power generated by the power transmitting circuit 102 into a pulse signal through ASK (Amplitude Shift Keying) modulation that utilizes amplitude shift. ASK modulation is modulation that utilizes amplitude shift, and is used for communication between an IC card and a card reader that wirelessly communicates with the IC card, and the like.

The communication circuit 104 changes the amplitude of power generated by the power transmitting circuit 102, by switching an analog multiplier and a load resister included in the communication circuit 104. Accordingly, the communication circuit 104 changes power generated by the power transmitting circuit 102 into a pulse signal. The pulse signal obtained by the communication circuit 104 changing the power is supplied to the antenna 108, and is transmitted as a request to the electronic device 200. Furthermore, the communication circuit 104 has a coding circuit that employs a predetermined encoding method. The communication circuit 104 can demodulate, with a decoding circuit, a response from the electronic device 200 that corresponds to the request transmitted to the electronic device 200, and information transmitted from the electronic device 200, according to a change in a current that flows through the antenna 108 and is detected in the matching circuit 103. Accordingly, the communication circuit 104 can receive, from the electronic device 200, a response to a request transmitted to the electronic device 200 and information that is transmitted from the electronic device 200, using a load modulation method. The communication circuit 104 transmits a request to the electronic device 200 according to an instruction from the CPU 105. Furthermore, in a case where the communication circuit 104 receives a response and information from the electronic device 200, the communication circuit 104 demodulates the received response and information, and supplies the response and information to the CPU 105.

The communication circuit 104 has a register for setting communication, and can adjust the transmission/reception sensitivity during communication, under control by the CPU 105.

In a case where the AC power source (not illustrated) and the communication apparatus 100 are connected, the CPU 105 controls the constituent elements of the communication apparatus 100 with power supplied from the AC power source (not illustrated) via the converter 111. The CPU 105 also controls operations of the constituent elements of the communication apparatus 100 by executing computer programs stored in the ROM 106. The CPU 105 controls power that is to be supplied to the electronic device 200 by controlling the power transmitting circuit 102. The CPU 105 also transmits a request to the electronic device 200 by controlling the communication circuit 104.

The ROM 106 stores computer programs for controlling operations of the constituent elements of the communication apparatus 100 and information such as parameters regarding the operations of the constituent elements. The ROM 106 also stores video data to be displayed on the display unit 112.

The RAM 107 is a rewritable volatile memory, and is used as a work area of the CPU 105. Also, the RAM 107 temporarily stores computer programs for controlling operations of constituent elements of the communication apparatus 100, information such as parameters regarding the operations of the constituent elements, information received by the communication circuit 104 from the electronic device 200, and the like.

The antenna 108 is an antenna for outputting, to the outside, power generated by the power transmitting circuit 102. The communication apparatus 100 supplies power to the electronic device 200 via the antenna 108, and transmits a request to the electronic device 200 via the antenna 108. Also, the communication apparatus 100 receives, via the antenna 108, a request from the electronic device 200, a response corresponding to a request transmitted to the electronic device 200, and information transmitted from the electronic device 200.

The timer 109 measures the current time and times regarding operations and processing performed in the constituent elements. In addition, threshold values for times that are measured by the timer 109 are stored in the ROM 106 in advance.

The operation unit 110 provides a user interface for operating the communication apparatus 100. The operation unit 110 has a power source button for the communication apparatus 100, a mode switching button for the communication apparatus 100, and the like, and these buttons are each constituted by a switch, a touch panel, or the like. The CPU 105 controls the communication apparatus 100 according to an instruction made by a user that has been input via the operation unit 110. Note that the operation unit 110 may be configured to control the communication apparatus 100 according to a remote control signal received from a remote controller (not illustrated).

When the AC power source (not illustrated) and the communication apparatus 100 are connected, the converter 111 converts AC power that is supplied from the AC power source (not illustrated), into DC power, and supplies the DC power obtained by performing the conversion to the entire communication apparatus 100.

The display unit 112 is a display unit that displays display content generated by the CPU 105. For example, the display unit 112 is constituted by a liquid crystal panel or an organic EL panel and the like, and a controller for controlling them.

The sensor controller 113 receives analog signals from various sensors such as the object sensors 114a and 114b and the azimuth angle sensor 115. The sensor controller 113 samples a received analog signal at a predetermined sampling frequency, converts the analog signal into a digital signal, and notifies the CPU 105 of the digital signal as digital information. Also, the sensor controller 113 may receive a control instruction from the CPU 105, and control the validity/invalidity of various sensors such as the object sensors 114a and 114b and the azimuth angle sensor 115. Note that, in the embodiments, the number of object sensors is two, but is not particularly limited, and may be three or more. In addition, the sensor controller 113 may control sensors other than the object sensors 114a and 114b and the azimuth angle sensor 115. Furthermore, in the case of an optical sensor, the value of the sensor changes under the influence of external light, and thus it is necessary to distinguish between changes caused by external light and changes caused by the intrusion of an object. Therefore, the sampling cycle of the sensor controller 113 is set as short as possible, and thereby the cause of the change can be distinguished such that, if a plurality of sensor values change at the same time, the change is caused by a change in the external light, and in a case where the values of a plurality of sensors change along a time axis, the change is caused by an extraneous object. Note that in a case where a simultaneous change of a plurality of sensor values is determined to have been caused by a change in external light, the reference values of the sensor values may be changed.

The object sensors 114a and 114b are sensors that detect the presence or absence of an object, and are sensors such as photoreflectors. The CPU 105 is notified of, via the sensor controller 113, detection information regarding an object detected by the object sensors 114a and 114b.

The azimuth angle sensor 115 is a sensor such as an electronic compass that performs azimuth angle detection by detecting the terrestrial magnetism. An azimuth angle sensor can detect terrestrial magnetism, and detect an azimuth angle from the intensity of the terrestrial magnetism. The CPU 105 is notified of, via the sensor controller 113, information regarding an azimuth angle detected by the azimuth angle sensor 115.

Next, the configuration of the electronic device 200 will be described. Note that a description will be given below using a digital still camera as an example of the electronic device 200.

The electronic device 200 has the antenna 201, a matching circuit 202, a rectification smoothing circuit 203, a communication circuit 204, a CPU 205, a ROM 206, a RAM 207, a power controller 208, a charge controller 209, the battery 210, a timer 211, an operation unit 212, a terminal for an external power source 213, an image sensing unit 214, a recording unit 215, a display unit 216, and a sensor unit 217.

The antenna 201 is an antenna for receiving power supplied from the communication apparatus 100. The electronic device 200 receives power from the communication apparatus 100 via the antenna 201, and receives a request. Also, the electronic device 200 transmits, via the antenna 201, a request for controlling the communication apparatus 100, a response corresponding to a request received from the communication apparatus 100, and predetermined information. In addition, a configuration may be adopted in which the position of the antenna 201 is movable, and the location to which the antenna has moved can be determined by the sensor unit 217.

The matching circuit 202 is a resonance circuit for performing impedance matching such that the antenna 201 resonates at the same frequency as the resonance frequency f of the communication apparatus 100. Similar to the matching circuit 103, the matching circuit 202 has a capacitor, a coil, a resister, and the like. The matching circuit 202 functions such that the antenna 201 resonates at the same frequency as the resonance frequency f of the communication apparatus 100. Also, the matching circuit 202 supplies power received by the antenna 201 to the rectification smoothing circuit 203. The matching circuit 202 supplies, to the communication circuit 204, a portion of the power received by the antenna 201 as a request, in the form of an AC wave.

The rectification smoothing circuit 203 removes a request and noise from power received by the antenna 201, and generates DC power. Furthermore, the rectification smoothing circuit 203 supplies the generated DC power to the power controller 208. Note that the rectification smoothing circuit 203 has a rectification diode, and generates DC power through either full-wave rectification or half-wave rectification. The DC power generated by the rectification smoothing circuit 203 is supplied to the power controller 208.

The communication circuit 204 analyzes a request supplied from the matching circuit 202 according to the communication apparatus 100 and a communication protocol determined in advance, and supplies the result of analyzing the request to the CPU 205.

The CPU 205 controls the communication circuit 204 so as to change ON/OFF of the load of a resister and the like included in the communication circuit 204, in order to transmit, to the communication apparatus 100, predetermined information and a response to a request transmitted from the communication apparatus 100 to the electronic device 200, and performs communication using the change as a load modulation signal. In a case where the load included in the communication circuit 204 changes, the current flowing through the antenna 108 changes. Accordingly, the communication apparatus 100 receives the predetermined information, the response to a request, and a request transmitted from the electronic device 200, by detecting the change in the current flowing through the antenna 108.

Similarly to the communication circuit 104, the communication circuit 204 converts power supplied from the power controller 208 into a pulse signal through ASK modulation that uses amplitude shift, and outputs a pulse signal via the matching circuit 202 and the antenna 201. Also, the communication circuit 204 can receive a load modulation signal in response to a transmitted ASK modulation signal, via the antenna 201 and the matching circuit 202.

The CPU 205 determines the type of request received by the communication circuit 204, according to an analysis result supplied from the communication circuit 204, and controls the electronic device 200 so as to perform processing and operations designated by a request code corresponding to the received request. The CPU 205 returns, via the communication circuit 204, responses to a request for device authentication from the communication apparatus 100 and a request for acquiring charge information.

In addition, the CPU 205 controls operations of the constituent elements of the electronic device 200 by executing computer programs stored in the ROM 206. The ROM 206 stores computer programs for controlling the operations of the constituent elements of the electronic device 200 and information such as parameters regarding the operations of the constituent elements. Also, the ROM 206 stores identification information regarding the electronic device 200, and the like. The identification information of the electronic device 200 indicates the ID of the electronic device 200, and further includes the manufacturer name of the electronic device 200, the device name of the electronic device 200, the manufacture date of the electronic device 200, and the like. The RAM 207 is a rewritable volatile memory, and temporarily stores computer programs for controlling operations of constituent elements of the electronic device 200, information such as parameters regarding the operations of the constituent elements, information transmitted from the communication apparatus 100, and the like.

The power controller 208 is constituted by a switching regulator or a linear regulator, and supplies DC power supplied from the rectification smoothing circuit 203 or the external power source 213, to the charge controller 209 and the electronic device 200.

In the case where power is supplied from the power controller 208, the charge controller 209 charges the battery 210 with the supplied power. Note that the charge controller 209 charges the battery 210 using a constant-voltage constant-current method. Also, the charge controller 209 periodically detects information regarding charging of the mounted battery 210, and supplies the information to the CPU 205. Note that the information regarding charging of the battery 210 is hereinafter referred to as “charge information”. The CPU 205 stores the charge information in the RAM 207.

Note that the charge information may include information indicating whether or not the battery 210 is fully charged, in addition to remaining capacity information indicating the remaining capacity of the battery 210, and may include information indicating the time that has elapsed since the charge controller 209 started charging the battery 210. The charge information may also include information indicating that the charge controller 209 is charging the battery 210 through constant-voltage control, information indicating that the charge controller 209 is charging the battery 210 through constant-current control, and the like. The charge information also includes information indicating that the charge controller 209 is performing software charge control or trickle charging of the battery 210, information indicating that the charge controller 209 is performing quick charging of the battery 210, and the like. The charge information further includes information regarding power required for the electronic device 200 to charge the battery 210, or information indicating whether or not the battery 210 is in a dangerous temperature state, and the like. The charge information includes information indicating the battery capacity that is required for operating the electronic device 200. Furthermore, the charge information includes information regarding the consumption of the battery 210 such as information indicating the degree to which the battery capacity has decreased, and information regarding how many times charging and discharging of the battery 210 has been repeated, in a case where discharge occurs when power from the communication apparatus is stopped.

The battery 210 is a battery that can be removed from the electronic device 200. Also, the battery 210 is a chargeable secondary battery, and is a lithium ion battery, for example. The battery 210 can supply power to the constituent elements of the electronic device 200. In a case where power is not supplied via the power controller 208, the battery 210 supplies power to the constituent elements of the electronic device 200. For example, in a case where the first power during communication that is set to be low is output from the communication apparatus, or power supply from the communication apparatus stops, power is supplied from the battery 210 to the constituent elements of the electronic device 200.

The timer 211 measures the current time and times regarding operations and processing performed in the constituent elements. In addition, threshold values for times that are measured by the timer 211 are stored in the ROM 206 in advance.

The operation unit 212 provides a user interface for operating the electronic device 200. The operation unit 212 has a power source button for operating the electronic device 200, a mode switching button for switching the operation mode of the electronic device 200, and the like, and these buttons are each constituted by a switch, a touch panel, or the like. The CPU 205 controls the electronic device 200 in accordance with an instruction made by a user that has been input via the operation unit 212. Note that the operation unit 212 may control the electronic device 200 according to a remote control signal received from a remote controller (not illustrated).

The external power source 213 is a power source that changes AC from an AC power source to DC, and supplies the DC. Note that the electronic device 200 in the embodiments operates with power supplied from the battery 210 or the communication apparatus 100. Accordingly, a description will be given assuming that the external power source 213 is not connected to the electronic device 200.

The image sensing unit 214 is a processing block that has an optical lens, a CMOS sensor, a digital image processing unit, and the like, and converts analog signals that have been input via the optical lens into digital data so as to acquire a shot image. The shot image acquired by the image sensing unit 214 is temporarily stored in the RAM 207, and is processed based on control of the CPU 205. For example, the shot image is recorded in a recording medium by the recording unit 215. The image sensing unit 214 also has a lens controller, and controls zoom, focus, diaphragm adjustment, and the like based on an instruction from the CPU 205, and notifies the CPU 205 of distance information obtained by converting the position of the lens.

The recording unit 215 is a processing block that is constituted by a recording medium with a large capacity, and stores/reads various types of data in/from the recording medium based on an instruction of the CPU 205. The recording medium is constituted by an incorporated flash memory, an incorporated hard disk, or a removable memory card, for example.

The display unit 216 is constituted by a liquid crystal panel, an organic EL panel, or the like, and displays operation screens, shot images, and the like based on an instruction of the CPU 205. The display unit 216 may be configured in a movable form such as a bari-angle screen, and in that case, position information regarding the display unit 216 is converted into digital information, and the CPU 205 is notified thereof.

The sensor unit 217 is a processing block that samples analog signals received from various sensors at a predetermined sampling frequency so as to convert the analog signals into digital signals, and notifies the CPU 205 of the digital signals as digital information. For example, the sensor unit 217 converts, into digital information, information from an azimuth angle sensor such as an electronic compass that detects terrestrial magnetism to obtain the azimuth angle, and notifies the CPU 205 of the digital information. Also, if the position of the antenna 201 changes, the sensor unit 217 detects position information regarding the antenna 201, and notifies the CPU 205.

Note that the antenna 108 and the antenna 201 may be a helical antenna or a loop antenna, or may be a planar antenna such as a meander line antenna.

In addition, in the first embodiment, processing performed by the communication apparatus 100 can also be applied in a system in which the communication apparatus 100 wirelessly supplies power to the electronic device 200 through electromagnetic field coupling. Similarly, in the first embodiment, processing performed by the electronic device 200 can also be applied in a system in which the communication apparatus 100 wirelessly supplies power to the electronic device 200 through electromagnetic field coupling.

In addition, by providing an electrode as the antenna 108 in the communication apparatus 100, and providing an electrode as the antenna 201 in the electronic device 200, the present invention can also be applied in a system in which the communication apparatus 100 supplies power to the electronic device 200 through electric field coupling.

In addition, the processing performed by the communication apparatus 100 and the processing performed by the electronic device 200 can also be applied in a system in which the communication apparatus 100 wirelessly supplies power to the electronic device 200 through electromagnetic induction.

In addition, in the first embodiment, the communication apparatus 100 wirelessly transmits power to the electronic device 200, and the electronic device 200 wirelessly receives the power from the communication apparatus 100. However, “wirelessly” may be reworded to “in a non-contact manner” or “with no contact point”.

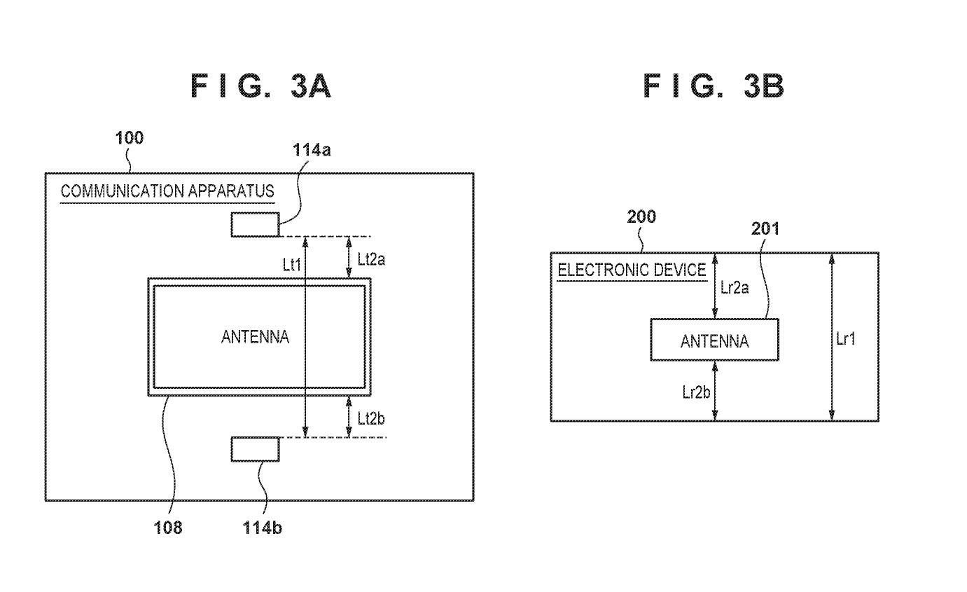

FIG. 3A shows the arrangement relationship between the antenna 108 and the object sensors 114a and 114b of the communication apparatus 100. FIG. 3B shows the relationship between the antenna 201 and the size of the housing exterior of the electronic device 200.

As shown in FIG. 3A, the object sensor 114a and the object sensor 114b are arranged outward of the antenna 108. Here, the distance between the object sensor 114a and the object sensor 114b is denoted by Lt1, the distance between the object sensor 114a and an outer edge of the antenna 108 is denoted by Lt2a, and the distance between the object sensor 114b and an outer edge of the antenna 108 is denoted by Lt2b. Note that the distance Lt2a and the distance Lt2b may or may not be equal.

As shown in FIG. 3B, the antenna 201 is accommodated in the housing of the electronic device 200. Here, a distance that is a size of the housing of the electronic device 200 is denoted by Lr1, the distance between a housing outer edge and an outer edge of the antenna 201 is denoted by Lr2a, the distance between the housing outer edge on the opposite side to Lr2a and an outer edge of the antenna 201 is denoted by Lr2b. Note that the distance Lr2a and the distance Lr2b may or may not be equal.

As described already, a digital camera is used as an example of the electronic device 200 in the embodiments. It is not unusual that a digital camera is equipped with a zoom lens and an openable/closeable display panel. Accordingly, the apparent size of such a digital camera is variable. The above distance Lt1 in the embodiments is larger than the distance Lr1 when the electronic device 200 is most compact. Therefore, in a case where the user places the electronic device 200 at the center of the antenna 108 of the communication apparatus 100 so as to face in a predetermined direction in a state where the electronic device 200 is compact, the object sensors 114a and 114b do not detect an object.

Overall Processing of Communication Apparatus 100

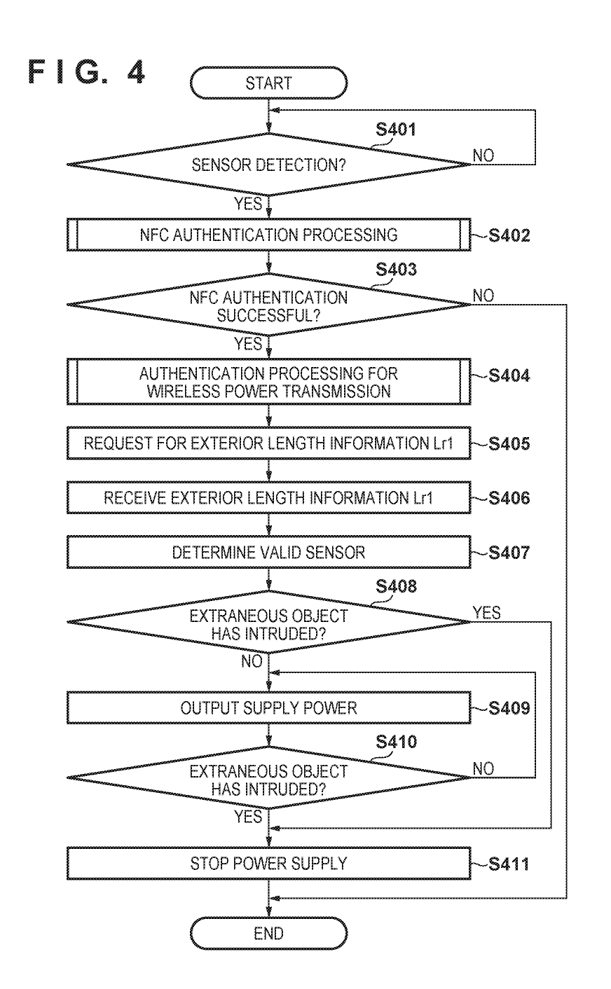

FIG. 4 shows an example of overall processing in the communication apparatus 100 in the first embodiment. Note that the control program in this flowchart that is stored in the ROM 106 is expanded in the RAM 107, and is executed by the CPU 105, in a state where the power source of the communication apparatus 100 is ON. Execution of processing of the control program in this flowchart may be repeated periodically.

In step S401, the CPU 105 acquires a sensor value from sensor information that is periodically sent from the sensor controller 113. The CPU 105 determines whether or not the sensor value has changed. If it is determined that the sensor value has changed by a predetermined value or more (YES in step S401), the CPU 105 advances the procedure from step S401 to step S402. If it is determined that the sensor value has not changed by the predetermined value or more (NO in step S401), the CPU 105 continues the processing of step S401.

In step S402, the CPU 105 controls the power transmitting circuit 102 so as to output the first power. The first power is power that makes it possible for at least the communication circuit 204 of the electronic device 200 to operate without receiving power supply from the battery 210. The CPU 105 outputs power, controls the communication circuit 104 so as to modulate the first power that has been output, transmits a request for detecting the electronic device 200, and receives a response to the request. For example, when inquiring as to whether or not there is a piece of NFC compliant equipment, a SENS_REQ request is transmitted in the case of Type A, a SENSB_REQ request is transmitted in the case of Type B, and a SENSF_REQ request is transmitted in the case of Type F. After transmitting a request, the CPU 105 performs NFC authentication processing upon receiving a response to the command. The CPU 105 performs processing for transmitting a request necessary for the command and receiving a response to the request, and then advances the procedure from step S402 to step S403.

In step S403, the CPU 105 determines whether or not NFC authentication was successful in step S402. If it is determined that NFC authentication was successful (YES in step S403), the CPU 105 advances the procedure from step S403 to step S404. If it is determined that NFC authentication was not successful (NO in step S403), the CPU 105 ends the procedure of this flowchart in step S403.

In step S404, the CPU 105 controls the communication circuit 104 so as to perform authentication processing for wireless power transmission. Specifically, the CPU 105 exchanges various types of information regarding wireless power transmission (e.g., whether or not wireless power transmission is supported, power that can be handled, the battery level, and whether or not there is a battery) configured in an NDEF (NFC Data Exchange Format). The CPU 105 stores, in the RAM 107, the NDEF information regarding wireless power transmission received by the communication circuit 104. After this, the CPU 105 transitions the procedure from step S404 to step S405.

In step S405, the CPU 105 controls the communication circuit 104 so as to transmit a request for acquiring information regarding the distance Lr1 described above with reference to FIG. 3B. After transmitting the request, the CPU 105 advances the procedure from step S405 to step S406.

In step S406, the CPU 105 controls the communication circuit 104 so as to receive a response to the request transmitted in step S405. The CPU 105 receives the information regarding the distance Lr1 from the electronic device 200, and stores the information in the RAM 107. After this, the CPU 105 advances the procedure from step S406 to step S407.

In step S407, the CPU 105 compares the received distance Lr1 of the electronic device 200 with the (known) distance Lt1 between the object sensors 114a and 114b, and determines whether or not the object sensors react to the electronic device 200 with the distance Lr1.

If the size of the electronic device 200 is a size with which the object sensors 114a and 114b react to the electronic device 200 (distance Lr1 distance Lt1), the CPU 105 invalidates the object sensors 114a and 114b. If the size of the electronic device 200 is not a size with which the object sensors 114a and 114b react to the electronic device 200 (distance Lr1<distance Lt1), the CPU 105 validates the object sensors 114a and 114b. The CPU 105 then advances the procedure from step S407 to step S408.

In step S408, the CPU 105 determines whether or not an extraneous object such as an NFC device other than the electronic device 200 has intruded. If a new extraneous object has intruded, the CPU 105 detects intrusion of the extraneous object according to the change in the sensor values of the object sensors 114a and 114b if the object sensors 114a and 114b are valid. If intrusion of an extraneous object is detected (YES in step S408), the CPU 105 advances the procedure in this flowchart from step S408 to step S411. If intrusion of an extraneous object is not detected (NO in step S408), the CPU 105 advances the procedure from step S408 to step S409.

In step S409, the CPU 105 controls the power transmitting circuit 102 so as to output the second power from the antenna 108, and wirelessly supplies the power to the electronic device 200. The CPU 105 advances the procedure from step S409 to step S410.

In step S410, the CPU 105 performs similar processing to step S408. If intrusion of an extraneous object is detected (YES in step S410), the CPU 105 advances the procedure in this flowchart from step S410 to step S411. If intrusion of an extraneous object is not detected (NO in step S410), the CPU 105 returns the procedure in this flowchart from step S410 to step S409.

In step S411, the CPU 105 controls the power transmitting circuit 102 so as to stop output of the second power, and ends the procedure in this flowchart. Note that the CPU 105 may lower the power to the first power that is lower than the second power instead of stopping the power.

Note that, in the first embodiment, a case has been described in which two object sensors are used, but more than two sensors may be arranged to perform the processing.

Overall Processing of Electronic Device 200

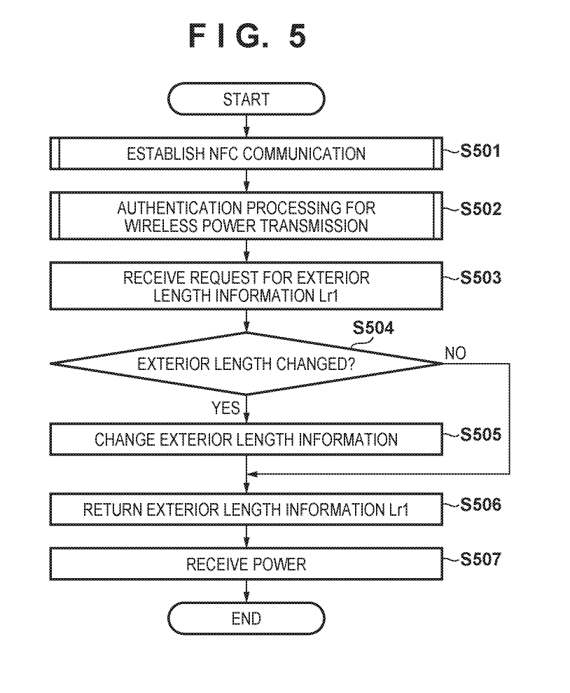

Next, processing in the electronic device 200 in the embodiments will be described with reference to the flowchart in FIG. 5. Note that the control program in this flowchart that is stored in the ROM 206 is expanded in the RAM 207, and is executed by the CPU 205, in a state where the CPU 205 of the electronic device 200 is ON. Execution of processing of the control program in this flowchart may be periodically repeated.

In step S501, the CPU 205 starts NFC authentication processing by controlling the communication circuit so as to receive a carrier signal that has been input via the antenna 201 and the matching circuit 202. The CPU 205 carries out NFC authentication processing by controlling the communication circuit 204 so as to receive a modulation signal superimposed on the received carrier signal, and return a response to each request. For example, a request such as a SENS_REQ request of NFC standard type A, a SENSB_REQ request of Type B, or a SENSF_REQ request of Type F is received. After receiving a request, the CPU 205 controls the communication circuit 204 so as to return, through load modulation, a SENS_RES response as a response to the Type A request, a SENSB_RES response as a response to the Type B request, or a SENSF_RES response as a response to the Type F request. The CPU 205 advances the procedure from step S501 to step S502.

In step S502, the CPU 205 controls the communication circuit 204 so as to perform authentication processing for wireless power transmission. Specifically, various types of information regarding wireless power transmission (e.g., whether or not wireless power transmission is supported, power that can be handled, the battery level, and whether or not there is a battery) configured in an NDEF are exchanged. The CPU 205 ends this processing, and advances the procedure in this flowchart from step S502 to step S503.

In step S503, the CPU 205 receives, from the communication circuit 204, a request for acquiring information regarding the distance Lr1. The CPU 205 advances the procedure from step S503 to step S504.

In step S504, the CPU 205 determines whether or not the distance Lr1 that is a size of the housing of the electronic device 200 has changed. Most digital cameras have a movable portion. For example, many digital cameras have a collapsible zoom lens or an openable/closeable display panel. Therefore, the CPU 205 acquires, at a predetermined interval, distance information obtained by converting the position of the lens of the image sensing unit 214 and position information regarding the display unit 216, and temporarily stores the information in the RAM 207. If the value of the distance Lr1 has changed (YES in step S504), the CPU 205 advances the procedure from step S504 to step S506. Accordingly, the CPU 205 functions as a size detector for the electronic device. If the value of the obtained distance Lr1 has not changed (NO in step S504), the CPU 205 advances the procedure from step S504 to step S505.

In step S505, the CPU 205 calculates the value of the distance Lr1 within the housing of the electronic device 200, from the distance information obtained by converting the position of the lens of the image sensing unit 214 and the position information regarding the display unit 216, which are stored in the RAM 207. For example, when the lens of the image sensing unit 214 is zooming, the position of the lens moves to a distant position from the housing exterior, and thus the distance Lr1 within the housing increases. Note that in the case of a digital camera whose lens can be removed, the type of the lens (model name) that is mounted also serves as a parameter when calculating the distance Lr1. Similarly, also regarding the position information regarding the display unit 216, in a case where a display unit such as a bari-angle liquid crystal panel is moved, the display unit moves to a distant position from the housing exterior, and thus the distance Lr1 within the housing increases. After calculating the value of the distance Lr1, the CPU 205 advances the procedure from step S505 to step S506.

In step S506, the CPU 205 controls the communication circuit 204 so as to transmit the value of the distance Lr1 to the communication apparatus 100 as a response to the request for acquiring information regarding the distance Lr1 received in the previous step S503. The CPU 205 then advances the procedure from step S506 to step S507.

In step S507, the CPU 205 performs processing for charging the battery 210 with power supplied from the communication apparatus 100 via the matching circuit 202, the rectification smoothing circuit 203, the power controller 208, and the charge controller 209. The CPU 205 continues the processing in step S507 while power supply from the communication apparatus 100 continues. The CPU 205 ends the procedure in this flowchart in step S507.

As described above, according to the first embodiment, the communication apparatus 100 determines the size of the electronic device 200 by communicating with the electronic device 200. The communication apparatus 100 then selects an object sensor that is determined to be valid from among a plurality of object sensors, according to the determined size. After that, while the second power (charging power) is being supplied to the electronic device 200, the object sensor determined to be valid is used for detecting an extraneous object, and thus accurate detection can be performed.

Note that, in the embodiments, two object sensors are used, but additional object sensors may be arranged at positions inward and outward of the object sensors 114a and 114b described in the embodiments, in the apparatus. In this case, if the size of the electronic device (Lr1 in the embodiments) is obtained by performing communication, object sensors other than an object sensor that has been determined to be valid (sensors determined to be invalid) are not used, and extraneous object intrusion can be determined using the object sensor determined to be valid, and thus various electronic devices can be supported.

### Second Embodiment

In the above first embodiment, only the distance Lr1 that is a parameter of the size of the housing of the electronic device 200 is used for determining the size of the housing. However, a case is possible in which the size of the housing cannot be accurately determined due to the centers of the antenna 108 and the antenna 201 being shifted from each other, depending on the position of the antenna 201. In the second embodiment, a processing form in which a communication apparatus 100 can determine whether or not there is an extraneous object while considering the position of an antenna 201 of an electronic device 200 will be described.

Note that the system configuration diagram in the second embodiment is similar to the configuration of the first embodiment shown in FIG. 1. Also, the block diagram of the power supply system in the second embodiment is similar to the configuration of the first embodiment shown in FIG. 2. Furthermore, the arrangement of an antenna and sensors in the communication apparatus 100 in this embodiment and the arrangement of an antenna and a housing exterior of the electronic device 200 are similar to the configurations of the first embodiment shown in FIGS. 3A and 3B. Note that a description will be given assuming that a sensor unit 217 of the electronic device 200 includes an azimuth angle sensor.

Overall Processing of Communication Apparatus 100

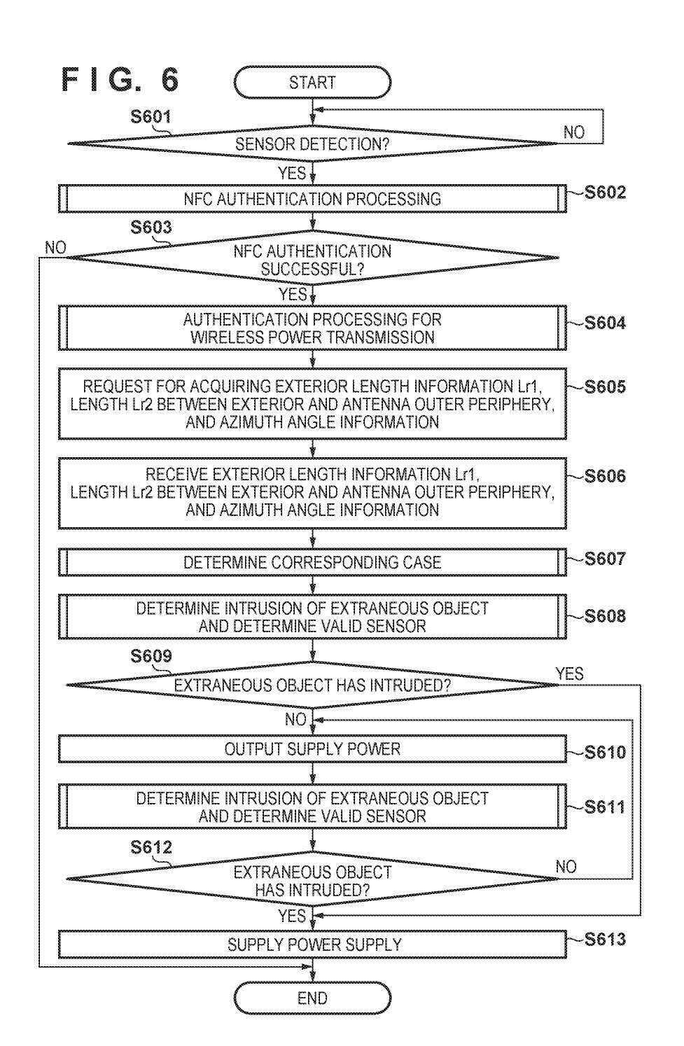

First, processing in the communication apparatus 100 in the second embodiment will be described with reference to the flowchart in FIG. 6. Note that the control program in this flowchart that is stored in a ROM 106 is expanded in a RAM 107, and is executed by a CPU 105, in a state where the power source of the communication apparatus 100 is ON. Execution of processing of the control program in this flowchart may be repeated periodically.

In step S601, the CPU 105 acquires a sensor value from sensor information that is periodically transmitted from a sensor controller 113. The CPU 105 then determines whether or not the sensor value has changed. Note that it is necessary to set a reference value before an object is detected, as a sensor value in advance, and thus the CPU 105 uses the value detected in this step as a reference value. In addition, in the case where detection values of a plurality of sensors change at the same time, it can be determined that the changes are caused by a change in the external environment such as external light, and thus the reference values of all of the sensors are changed at the same time. In addition, in a case where the value of a specific sensor (a signal level) is always different from the values of the other sensors, the sensor is determined to be dirty, and in order to notify (announce) the occurrence of a sensor failure, a display unit 112 is controlled so as to display a message indicating a sensor abnormality (a sensor error). If it is determined that the sensor value has changed by a predetermined value or more (YES in step S601), the CPU 105 advances the procedure from step S601 to step S602. If it is determined that the sensor value has not changed by the predetermined value or more (NO in step S601), the CPU 105 continues the processing of step S601.

In step S602, the CPU 105 controls a power transmitting circuit 102 so as to output first power. For example, the CPU 105 outputs, as the first power, power with which at least a communication circuit 204 of the electronic device 200 can operate without receiving power supply from a battery 210. After outputting power, the CPU 105 controls a communication circuit 104 so as to modulate the first power that has been output, transmit a request for detecting the electronic device 200, and receive a response to the request. For example, when inquiring as to whether or not there is a piece of NFC compliant equipment, a SENS_REQ request is transmitted in the case of Type A, a SENSB_REQ request is transmitted in the case of Type B, and a SENSF_REQ request is transmitted in the case of Type F. After transmitting a request, the CPU 105 performs NFC authentication processing upon receiving a response to the command. The CPU 105 performs processing for transmitting a request necessary for the command and receiving a response to the request, and then advances the procedure from step S602 to step S603.

In step S603, the CPU 105 determines whether or not NFC authentication in step S602 was successful. If it is determined that NFC authentication was successful (YES in step S603), the CPU 105 advances the procedure from step S603 to step S604. On the other hand, if it is determined that NFC authentication was not successful (NO in step S603), the CPU 105 ends the procedure.

In step S604, the CPU 105 controls the communication circuit 104 so as to perform authentication processing for wireless power transmission. Specifically, various types of information regarding wireless power transmission (e.g., whether or not wireless power transmission is supported, power that can be handled, the battery level, and whether or not there is a battery) configured in an NDEF (NFC Data Exchange Format) are exchanged. The CPU 105 stores, to the RAM 107, the NDEF information regarding wireless power transmission received by the communication circuit 104. The CPU 105 then transitions the procedure from step S604 to step S605.

In step S605, the CPU 105 controls the communication circuit 104 so as to transmit a request for acquiring information regarding the distance Lr1 and the distances Lr2a and Lr2b each between a housing outer edge and an outer edge of the antenna 201, which have been described with reference to FIG. 3B, and azimuth angle information regarding the electronic device 200. After transmitting this request, the CPU 105 advances the procedure from step S605 to step S606.

In step S606, the CPU 105 controls the communication circuit 104 so as to receive a response to the request transmitted in step S605. The CPU 105 receives, from the electronic device 200, information regarding the distance Lr1, the distances Lr2a and Lr2b each between a housing outer edge and an outer edge of the antenna 201, and azimuth angle information regarding the electronic device 200, and stores the received information to the RAM 106. The CPU 105 advances the procedure from step S606 to step S607.

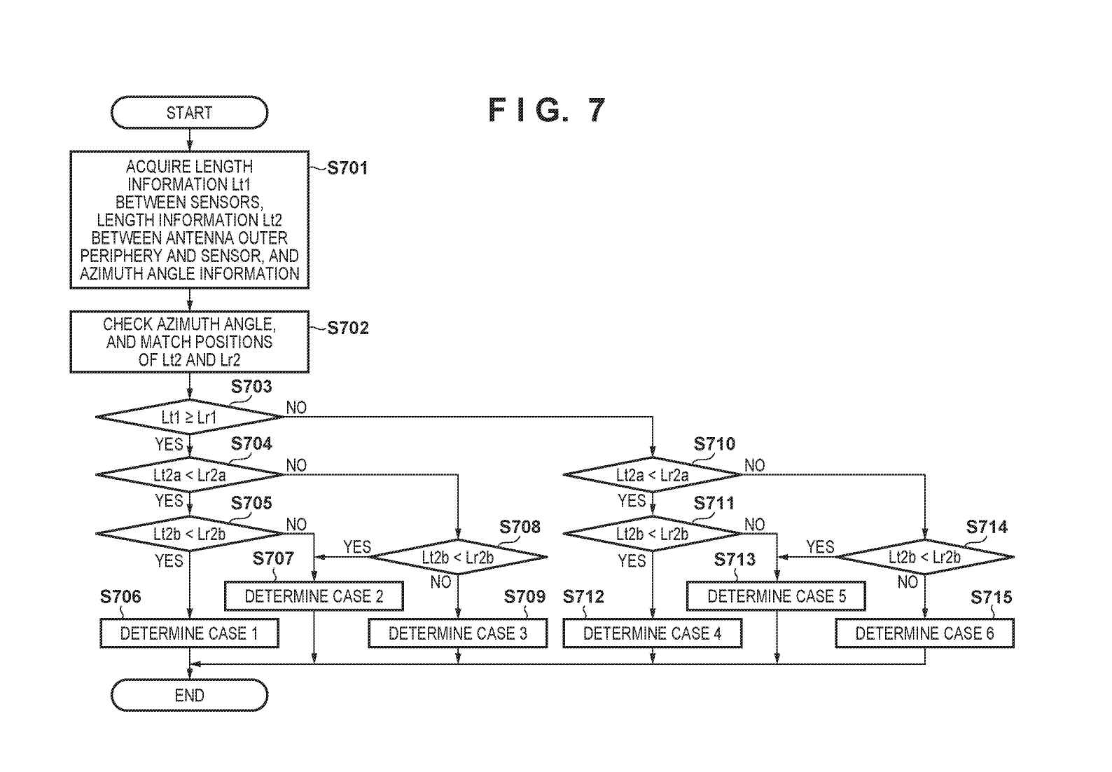

In step S607, the CPU 105 performs processing for determining which case the current state corresponds to, based on the information received in step S606. This processing will be described later in detail with reference to FIG. 7. The CPU 105 advances the procedure from step S607 to step S608.

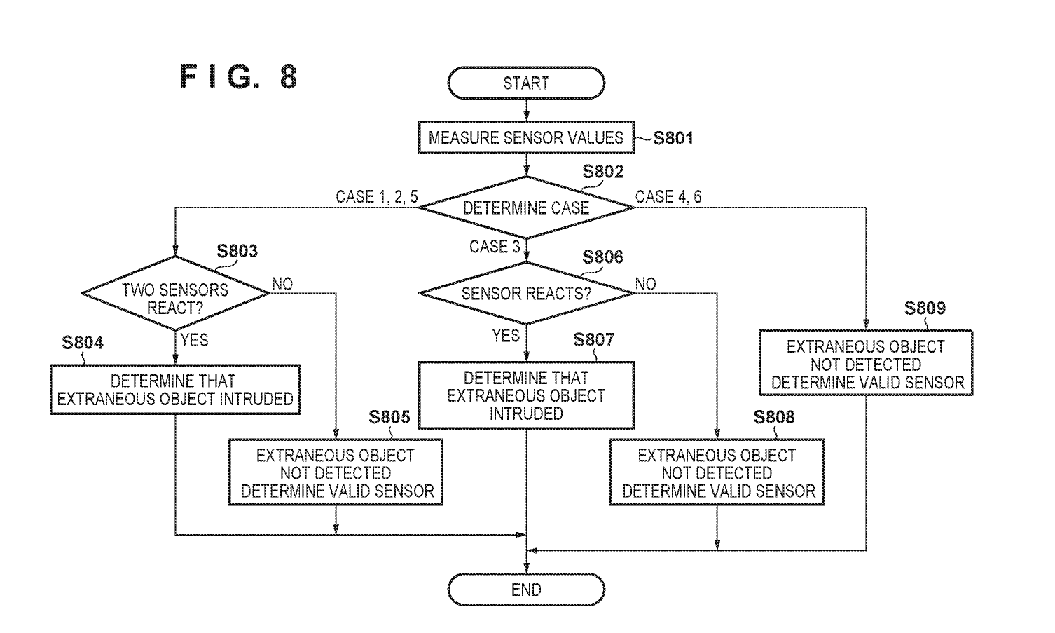

In step S608, the CPU 105 determines a valid sensor, and determines whether or not an extraneous object such as an NFC device other than the electronic device 200 has intruded. This processing will be described later in detail with reference to FIG. 8. The CPU 105 advances the procedure from step S608 to step S609.

In step S609, the CPU 105 determines whether or not an extraneous object such as an NFC device other than the electronic device 200 has intruded, based on the result in step S608. If it is determined that an extraneous object has intruded (YES in step S609), the CPU 105 advances the procedure from step S609 to step S613. If intrusion of an extraneous object is not detected (NO in step S609), the CPU 105 advances the procedure from step S609 to step S610.

In step S610, the CPU 105 controls the power transmitting circuit 102 so as to output second power from an antenna 108, and wirelessly supply the power to the electronic device 200. Accordingly, the electronic device 200 charges the battery 210. The CPU 105 advances the procedure from step S610 to step S611.

Similarly to step S608, in step S611, the CPU 105 determines a valid sensor, and determines whether or not an extraneous object such as an NFC device other than the electronic device 200 has intruded. This processing will be described later in detail with reference to FIG. 8.

In step S612, the CPU 105 performs processing similar to step S609. If it is determined that an extraneous object has intruded (YES in step S612), the CPU 105 advances the procedure from step S612 to step S613. If it is determined that an extraneous object has not intruded (NO in step S612), the CPU 105 returns the procedure from step S612 to step S610.

In step S613, the CPU 105 controls the power transmitting circuit 102 so as to stop output of the second power, and ends the procedure in this flowchart. Note that the CPU 105 may lower the level of the power to a predetermined power level such as the level of the first power that is lower than the level of the second power, instead of stopping power.

Next, an example of case determination processing in the communication apparatus 100 will be described with reference to the flowchart in FIG. 7. Note that the control program in this flowchart that is stored in the ROM 106 is expanded in the RAM 107, and is executed by the CPU 105, in a state where the power source of the communication apparatus 100 is ON. Execution of processing of the control program in this flowchart may be repeated periodically.

In step S701, the CPU 105 acquires, from the ROM 106, the distance Lt1 between object sensors 114a and 114b. The CPU 105 also acquires, from the ROM 106, the distance Lt2a between the object sensor 114a and an outer edge of the antenna 108 and the distance Lt2b between the object sensor 114b and an outer edge of the antenna 108. The CPU 105 then acquires azimuth angle information from an azimuth angle sensor 115. The CPU 105 then advances the procedure from step S701 to step S702.

In step S702, the CPU 105 determines the position of the electronic device 200 placed on the communication apparatus 100, from the azimuth angle information regarding the communication apparatus 100 acquired in step S701 and the azimuth angle information regarding the electronic device 200 received in step S606 in FIG. 6. Specifically, the CPU 105 calculates an angle from the azimuth angle information regarding the electronic device 200, based on the azimuth angle information regarding the communication apparatus 100, and determines an orientation in which the electronic device 200 is placed (a relative orientation). For example, in a case where the electronic device 200 is placed rotated by 180 degrees, the value of the distance Lr2a and the value of the distance Lr2b are replaced with each other. The CPU 105 then advances the procedure from step S702 to step S703.

In step S703, the CPU 105 compares the distance Lt1 with the distance Lr1. If it is determined that the distance Lt1 is larger than or equal to the distance Lr1 (YES in step S703), the CPU 105 advances the procedure from step S703 to step S704. If it is determined that the distance Lt1 is smaller than the distance Lr1 (NO in step S703), the CPU 105 advances the procedure from step S703 to step S710.

In step S704, the CPU 105 compares the distance Lt2a with the distance Lr2a. If it is determined that the distance Lr2a is larger than the distance Lt2a (YES in step S704), the CPU 105 advances the procedure from step S704 to step S705. If it is determined that the distance Lr2a is smaller than or equal to the distance Lt2a (NO in step S704), the CPU 105 advances the procedure from step S704 to step S708.

In step S705, the CPU 105 compares the distance Lt2b with the distance Lr2b. If it is determined that the distance Lr2b is larger than the distance Lt2b (YES in step S705), the CPU 105 advances the procedure from step S705 to step S706. If it is determined that the distance Lr2b is smaller than or equal to the distance Lt2b (NO in step S705), the CPU 105 advances the procedure from step S705 to step S707.

In step S706, the CPU 105 determines a case 1 as the case determination, and sets the case value of the RAM 107 to “1”. The CPU 105 then ends the procedure in step S706.

In step S707, the CPU 105 determines a case 2 as the case determination, and sets the case value of the RAM 107 to “2”. The CPU 105 ends the procedure in step S707.

In step S708, the CPU 105 compares the distance Lt2b with the distance Lr2b. If it is determined that the distance Lr2b is larger than the distance Lt2b (YES in step S708), the CPU 105 advances the procedure from step S708 to step S707. If it is determined that the distance Lr2b is smaller than or equal to the distance Lt2b (NO in step S708), the CPU 105 advances the procedure from step S708 to step S709.

In step S709, the CPU 105 determines a case 3 as the case determination, and sets the case value of the RAM 107 to “3”. The CPU 105 ends the procedure in step S709.

In step S710, the CPU 105 compares the distance Lt2a with the distance Lr2a. If it is determined that the distance Lr2a is larger than the distance Lt2a (YES in step S710), the CPU 105 advances the procedure from step S710 to step S712. If it is determined that the distance Lr2a is smaller than or equal to the distance Lt2a (NO in step S710), the CPU 105 advances the procedure from step S710 to step S715.

In step S711, the CPU 105 compares the distance Lt2b with the distance Lr2b. If it is determined that the distance Lr2b is larger than the distance Lt2b (YES in step S711), the CPU 105 advances the procedure from step S711 to step S712. If it is determined that the distance Lr2b is smaller than or equal to the distance Lt2b (NO in step S711), the CPU 105 advances the procedure from step S711 to step S713.

In step S712, the CPU 105 determines a case 4 as the case determination, and sets the case value of the RAM 107 to “4”. The CPU 105 ends the procedure in step S712.

In step S713, the CPU 105 determines a case 5 as the case determination, and sets the case value of the RAM 107 to “5”. The CPU 105 ends the procedure in step S713.

In step S714, the CPU 105 compares the distance Lt2b with the distance Lr2b. If it is determined that the distance Lr2b is larger than the distance Lt2b (YES in step S714), the CPU 105 advances the procedure from step S714 to step S713. If it is determined that the distance Lr2b is smaller than or equal to the distance Lt2b (NO in step S714), the CPU 105 advances the procedure from step S714 to step S715.

In step S715, the CPU 105 determines a case 6 as the case determination, and sets the case value of the RAM 107 to “6”. The CPU 105 ends the procedure in step S715.

Next, processing for determining a valid sensor and processing for determining an extraneous object, in the communication apparatus 100, will be described with reference to the flowchart in FIG. 8. This processing is subroutine processing of steps S608 and S611 described above with reference to FIG. 6. Note that the control program in this flowchart that is stored in the ROM 106 is expanded in the RAM 107, and is executed by the CPU 105, in a state where the power source of the communication apparatus 100 is ON. Execution of processing of the control program in this flowchart may be repeated periodically.

In step S801, the CPU 105 acquires the most recent values of the object sensors 114a and 114b and the azimuth angle sensor 115 via the sensor controller 113, and stores the acquired values to the RAM 107. The CPU 105 then advances the procedure from step S801 to step S802.

In step S802, the CPU 105 performs determination based on the case value determined in the above-described flowchart in FIG. 7 and stored in the RAM 107. If it is determined that the case value is one of 1, 2, and 5 (the case 1, 2, or 5 in step S802), the CPU 105 advances the procedure from step S802 to step S803. If it is determined that the case value is 3 (the case 3 in step S802), the CPU 105 advances the procedure from step S802 to step 3806. If it is determined that the case value is 4 or 6 (4 or 6 in step S802), the CPU 105 advances the procedure from step S802 to step S809.

In step S803, the CPU 105 determines whether or not both the values of the object sensor 114a and the object sensor 114b have changed by a predetermined threshold value relative to a reference value. If both the values of the object sensor 114a and the object sensor 114b have changed (YES in step S803), the CPU 105 advances the procedure in this flowchart from step S803 to step S804. If one of the values of the object sensor 114a and the object sensor 114b has changed, or both values have not changed (NO in step S803), the CPU 105 advances the procedure in this flowchart from step S803 to step S805.

In step S804, due to a reaction from a sensor that otherwise does not react, the CPU 105 determines that an extraneous object has intruded. The CPU 105 ends the procedure in this flowchart in step S804.

In step S805, the CPU 105 determines that an extraneous object has not intruded. The CPU 105 determines that the electronic device 200 has been placed on a sensor, out of the object sensor 114a and the object sensor 114b, whose value has changed by the threshold value or more relative to the reference value, and uses the sensor as a removal detection sensor when the electronic device 200 moves. The CPU 105 determines that the electronic device 200 is not placed on a sensor out of the object sensor 114a and the object sensor 114b whose value has not changed by the threshold value or more relative to the reference value, and uses the sensor as an extraneous object detection sensor for detecting the intrusion of an extraneous object. The CPU 105 ends the procedure in this flowchart in step S805.

In step S806, the CPU 105 determines whether or not one of the sensor values of the object sensor 114a and the object sensor 114b has changed by the predetermined threshold value or more relative to the reference value. If it is determined that one of the sensor values of the object sensor 114a and the object sensor 114b has changed (YES in step S806), the CPU 105 advances the procedure from step S806 to step S807. If it is determined that the sensor values of both the object sensor 114a and the sensor value of the object sensor 114b have not changed (NO in step S806), the CPU 105 advances the procedure from step S806 to step S808.

In step S807, due to a reaction from a sensor that otherwise does not react, the CPU 105 determines that an extraneous object has intruded. The CPU 105 then ends the procedure in this flowchart.

In step S808, the CPU 105 performs processing similar to step S805, and ends the procedure in this flowchart. In step S809, the CPU 105 performs processing similar to step S805, and ends the procedure in this flowchart.

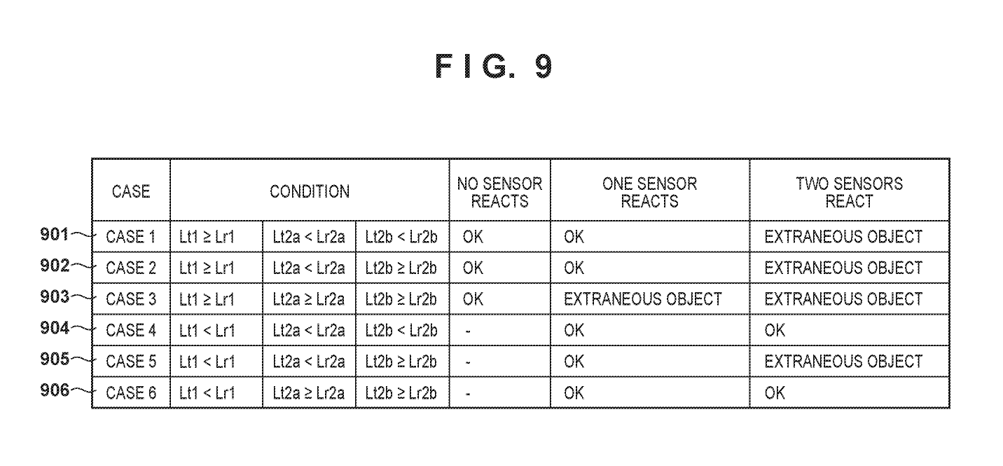

An example of the relationship between the cases and determination of a valid sensor and determination of an extraneous object, which have been described with reference to the flowcharts in FIGS. 7 and 8, will be described with reference to FIG. 9. It can be said that FIG. 9 shows a table for determining a valid sensor and determining an extraneous object.

In a row 901, a situation in which a sensor reacts under the conditions in case 1 is indicated. It is indicated that, in the case 1 where Lt1 is larger than or equal to Lr1, it is not possible for the two sensors to react, and thus if the two sensors react, it is determined that an extraneous object has been placed.

In a row 902, a situation in which a sensor reacts under the conditions in case 2 is indicated. Since Lt1 is larger than or equal to Lr1 similar to case 1, it is not possible for the two sensors to react, and thus if the two sensors react, it is determined that an extraneous object has been placed.

In a row 903, a situation in which a sensor reacts under the conditions in case 3 is indicated. Since Lt1 is larger than or equal to Lr1 similar to the cases 1 and 2, and in addition, Lt2a is larger than or equal to Lr2a, and Lt2b is larger than or equal to Lr2b, it is not possible for either sensor to react, and thus if one or more sensors react, it is determined that an extraneous object has been placed.

In a row 904, a situation in which a sensor reacts under the conditions in case 4 is indicated. In case 4, Lt1 is smaller than Lr1, and thus it is conceivable that the electronic device 200 is placed on one of the sensors. In case 4 where, furthermore, Lt2a is smaller than Lr2a, and Lt2b is smaller than Lr2b, both the two sensors react, and thus it is determined that an extraneous object cannot intrude.

In a row 905, a situation in which a sensor reacts under the conditions in case 5 is indicated. In case 5, Lt1 is smaller than Lr1 similar to the case 4, indicating that the electronic device 200 is placed on one of the sensors. However, Lt2b is larger than or equal to Lr2b, and thus it is determined to be impossible for the two sensors to react, and if the two sensors react, it is determined that an extraneous object has been placed. In a row 906, a situation in which a sensor reacts under the conditions in case 6 is indicated. Basically, the case 6 is a case that does not exist. In the case 6, Lt1 is smaller than Lr1 similar to the case 4, and thus it is determined that it is not possible for an extraneous object to intrude.

Note that, in the processing in the second embodiment, a case has been described in which two object sensors are used, but more than two sensors may be arranged to perform the processing. For example, when three or more sensors are arranged, it suffices to add one or more cases accordingly, and determine whether or not an extraneous object has been placed, similarly. In particular, in a case were four sensors are arranged on the four sides of the antenna 108, the processing for two sensors may be combined with the processing for the other two sensors.

Overall Processing of Electronic Device 200

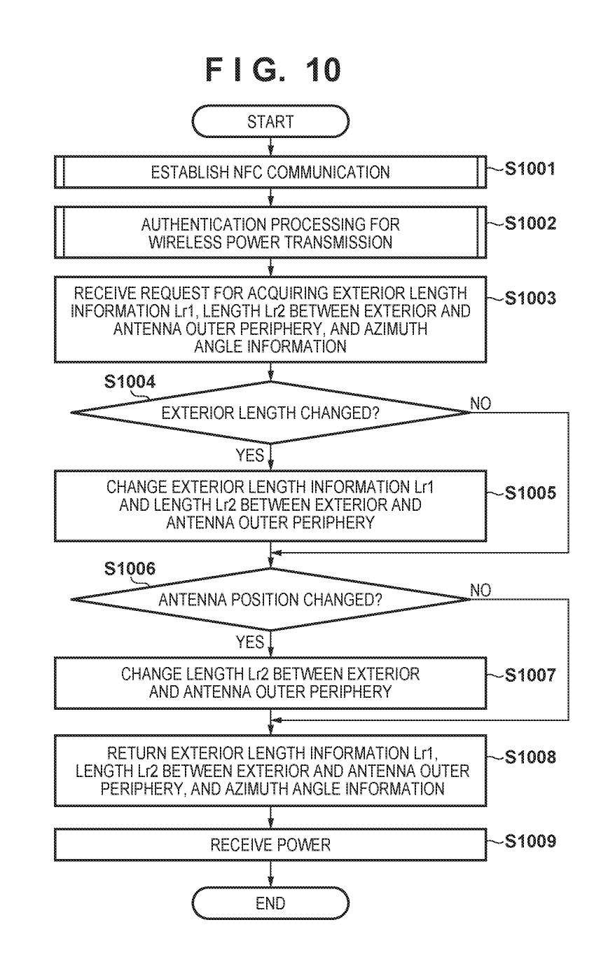

FIG. 10 shows an example of overall processing in the electronic device 200 in the second embodiment. Note that the control program in this flowchart that is stored in a ROM 206 is expanded in a RAM 207, and is executed by a CPU 205 of the electronic device 200, in a state where the CPU 205 is ON. Execution of the processing of the control program in this flowchart may be repeated periodically.

In step S1001, the CPU 205 starts NFC authentication processing by controlling a communication circuit 204 so as to receive a carrier signal that has been input via an antenna 201 and a matching circuit 202. The CPU 205 carries out NFC authentication processing by controlling the communication circuit 204 so as to receive a modulation signal superimposed on the received carrier signal, and return a response to each request. For example, a request such as a SENS_REQ request of NFC standard Type A, a SENSB_REQ request of Type B, or a SENSF_REQ request of Type F is received. After receiving a request, the CPU 205 controls the communication circuit 204 so as to return, through load modulation, a SENS_RES response as a response to the Type A request, a SENSB_RES response as a response to the Type B request, or a SENSF_RES response as a response to the Type F request. The CPU 205 then advances the procedure from step S1001 to step S1002.

In step S1002, the CPU 205 controls the communication circuit 204 so as to perform authentication processing for wireless power transmission. Specifically, the CPU 205 exchanges various types of information regarding wireless power transmission (e.g., whether or not wireless power transmission is supported, power that can be handled, the battery level, and whether or not there is a battery) configured in an NDEF. The CPU 205 ends this processing, and advances the procedure from step S1002 to step S1003.

In step S1003, the CPU 205 receives, via the communication circuit 204, a request for acquiring information regarding the distance Lr1, the distances Lr2a and Lr2b each between a housing outer edge and an outer edge of the antenna 201, which have been described with reference to FIG. 3B, and azimuth angle information regarding the electronic device 200. The CPU 205 then advances the procedure from step S1003 to step S1004.

In step S1004, the CPU 205 determines whether or not the distance Lr1 of the electronic device 200 has changed, and the CPU 205 determines whether or not distance information acquired via an image sensing unit 214, distance information acquired via the display unit 216, and distance information acquired via the sensor unit 217 have changed. If it is determined that the distance Lr1 has changed (YES in step S1004), the CPU 205 advances the procedure from step S1004 to step S1005. If it is determined that the distance Lr1 has not changed (NO in step S1004), the CPU 205 advances the procedure from step S1004 to step S1006.

In step S1005, the CPU 205 changes the value of the distance Lr1 and the values of the distance Lr2a and the distance Lr2b based on the distance information acquired via the image sensing unit 215, the distance information acquired via the display unit 216 and the distance information acquired via the sensor unit 217, and stores the changed values to the RAM 207. For example, the value of the distance Lr1 inside of the housing of the electronic device 200 is calculated from the distance information obtained by converting the position of the lens of the image sensing unit 214 and the position information regarding the display unit 216. For example, when the lens of the image sensing unit 214 is zooming, the lens moves to a distant position from the housing exterior, and thus the distance Lr1 within the housing increases. Similarly, also regarding position information regarding the display unit 216, when a display unit such as a bari-angle liquid crystal panel is moved, the display unit moves to a distant position from the housing exterior, and thus the distance Lr1 within the housing increases. Lr2a and Lr2b can be calculated similarly. The CPU 205 then advances the procedure from step S1005 to step S1006.

In step S1006, the CPU 205 determines whether or not the position of the antenna 201 has changed, from antenna position information acquired from the sensor unit 217. If it is determined that the antenna position has changed (YES in step S1006), the CPU 205 advances the procedure from step S1006 to step S1007. If it is determined that the antenna position has not changed (NO in step S1006), the CPU 205 advances the procedure from step S1006 to step S1008.

In step S1007, the CPU 205 changes the values of the distance Lr2a and the distance Lr2b based on the position to which the antenna 201 has moved, and stores the values after being changed to the RAM 207. The CPU 205 then advances the procedure from step S1007 to step S1008.

In step S1008, the CPU 205 controls the communication circuit 204 so as to transmit the values stored in the RAM 207, as a response to the request for acquiring information regarding the distance Lr1, the distance Lr2a, and the distance Lr2b, and azimuth angle information received in step S1003. The CPU 205 then advances the procedure from step S1008 to step S1009.

In step S1009, the CPU 205 charges the battery 210 with power supplied from the communication apparatus 100, via the matching circuit 202, a rectification smoothing circuit 203, a power controller 208, and a charge controller 209. The CPU 205 continues processing in step S1009 while power supply from the communication apparatus 100 continues. The CPU 205 ends the procedure in this flowchart in step S1009.

As described above, according to the second embodiment, even if the position at which the electronic device 200 is placed on the communication apparatus 100 is not at the center of the antenna 108, in a case where an NFC device other than the electronic device 200 is placed during power supply to the electronic device 200, extraneous object can be detected.

The first and second embodiments according to the present invention have been described above, but the communication apparatus according to the present invention is not limited to the communication apparatus 100 described in those embodiments. In addition, the electronic device 200 according to the present invention is not limited to the electronic device 200 described in this embodiment. For example, the communication apparatus 100 and the electronic device 200 according to the present invention can also be realized as a system constituted by a plurality of apparatuses.

In addition, in the embodiments, an example has been described in which a plurality of (two in the embodiments) object sensors on a placement stand are provided, as a configuration for detecting an object on a placement stand on which an electronic device is placed, in the communication apparatus 100. Also, an example has been described in which photoreflectors are used as the object sensors. However, the sensors that perform object detection are not limited to photoreflectors, and may be contact sensors. Importantly, it suffices for the communication apparatus 100 to be able to function using the communication range of the communication apparatus 100 excluding the range occupied by the electronic device 200, as a range for detecting intrusion of an extraneous object, while supplying power to the electronic device 200.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. the storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-040915, filed Mar. 3, 2017, which is hereby incorporated by reference herein in its entirety.

What is claimed is:

1. A power supply apparatus that wirelessly supplies power to an electronic device, comprising:
a communication unit for performing power transmission and transmission/reception of information in a non-contact manner;
a detector for detecting intrusion of an object in a communication range of the communication unit;
an acquisition unit for acquiring information indicating a size of an electronic device from the electronic device via the communication unit;
a determiner for determining a detection range in which intrusion of an object is detected by the detector, based on the acquired information; and
a controller for supplying power to the electronic device via the communication unit,
wherein the controller controls power supply to the electronic device based on detection of intrusion of an object in the detection range performed by the detector, during power supply to the electronic device.

2. The apparatus according to claim 1, wherein
in a case where intrusion of an object is detected in the detection range by the detector, the controller stops power supply to the electronic device, or switches to supply of power that is lower than charging power.

3. The apparatus according to claim 1, wherein
the detector detects whether or not an object has intruded, based on signals from a plurality of object sensors provided in a placement stand that accommodates an antenna for wirelessly supplying power, and on which an electronic device is placed.

4. The apparatus according to claim 3, wherein
the plurality of object sensors are provided at positions outward of an outer periphery of the antenna.

5. The apparatus according to claim 3, wherein
the determiner determines the detection range by determining an object sensor, out of the plurality of object sensors, to be validated based on the information acquired by the acquisition unit.

6. The apparatus according to claim 3, further comprising:
an azimuth angle detector for detecting an orientation of the power supply apparatus,
wherein the acquisition unit further acquires, from the electronic device, information indicating an orientation of the electronic device, and
the determiner determines, from an azimuth angle detected by the azimuth angle detector and the information acquired by the acquisition unit, a relative orientation of the electronic device relative to the power supply apparatus, and determines the detection range by determining an object sensor, out of the plurality of object sensors, to be validated from the relative orientation and the information indicating the size of the electronic device.

7. The apparatus according to claim 5, wherein
the controller uses an object sensor, out of the plurality of object sensors, determined to be invalid to detect movement of an object.

8. The apparatus according to claim 3, wherein
the controller includes an announcement unit for announcing, if there is an abnormal signal level, the abnormal signal level as a sensor error, based on signal levels of the respective object sensors.

9. The apparatus according to claim 3, wherein
in a case where signal levels from the plurality of object sensors simultaneously exceed their threshold values that have been set in advance, the controller determines that there has been a change in an external environment, and changes the threshold values of the respective object sensors.

10. The apparatus according to claim 1, wherein
the communication unit is an NFC (Near Field Communication) communication unit.

11. An electronic device that charges a chargeable battery using an external power supply apparatus via a communication unit, and includes the communication unit that operates using power from the battery, and receives power and performs transmission/reception of information in a non-contact manner, the electronic device comprising:
a transmission unit for transmitting information indicating a size of the electronic device to the power supply apparatus via the communication unit, and
a charging unit for charging the battery with power that is supplied from the power supply apparatus.

12. The device according to claim 11, further comprising:
a size detector for detecting a current size of the electronic device based on a state of a movable portion of the electronic device,
wherein the transmission unit transmits information indicating the size that has been detected by the size detector.

13. The device according to claim 11, further comprising:
an azimuth angle sensor for detecting an azimuth angle of the electronic device,
wherein the transmission unit further transmits information indicating the azimuth angle detected by the azimuth angle sensor.

14. A control method of a power supply apparatus that includes a communication unit for performing power transmission and transmission/reception of information in a non-contact manner and a detector for detecting intrusion of an object in a communication range of the communication unit, and wirelessly supplies power to an electronic device, the control method comprising:
acquiring information indicating a size of an electronic device from the electronic device via the communication unit;
determining a detection range in which intrusion of an object is detected by the detector, based on the acquired information; and
controlling power supply to the electronic device via the communication unit,
wherein in the controlling,
power supply to the electronic device is controlled based on detection of intrusion of an object in the detection range performed by the detector, during power supply to the electronic device.

15. A control method of an electronic device that charges a chargeable battery using an external power supply apparatus, and includes a communication unit that operates using power from the battery, and receives power and performs transmission/reception of information in a non-contact manner, the control method comprising:
transmitting information indicating a size of the electronic device to the power supply apparatus via the communication unit; and
charging the battery with power that is supplied from the power supply apparatus.

16. A storage medium that stores a program for executing steps in a method for causing a computer that includes a communication unit for performing power transmission and transmission/reception of information in a non-contact manner and a detector for detecting intrusion of an object in a communication range of the communication unit to function as a power supply apparatus that wirelessly supplies power to an electronic device, the method comprising:
acquiring information indicating a size of an electronic device from the electronic device via the communication unit;
determining a detection range in which intrusion of an object is detected by the detector, based on the acquired information; and
controlling power supply to the electronic device via the communication unit,
wherein in the controlling,
power supply to the electronic device is controlled based on detection of intrusion of an object in the detection range performed by the detector, during power supply to the electronic device.

17. A storage medium that stores a program for executing steps in a method for causing a computer that includes a communication unit that operates using power from a chargeable battery, and receives power and performs transmission/reception of information in a non-contact manner to function as an electronic device that charges the battery using an external power supply apparatus, the method comprising:
transmitting information indicating a size of the electronic device to the power supply apparatus via the communication unit; and
charging the battery with power that is supplied from the power supply apparatus.

18. A power supply system constituted by a power supply apparatus that wirelessly supplies power to an electronic device and an electronic device that receives power from the power supply apparatus,
wherein the power supply apparatus includes:
a first communication unit for performing power transmission and transmission/reception of information in a non-contact manner,
a detector for detecting intrusion of an object in a communication range of the first communication unit,
an acquisition unit for acquiring information indicating a size of an electronic device from the electronic device via the first communication unit,
a determiner for determining a detection range in which intrusion of an object is detected by the detector, based on the acquired information, and
a controller for supplying power to the electronic device via the first communication unit, and
the controller controls power supply to the electronic device based on detection of intrusion of an object in the detection range performed by the detector, during power supply to the electronic device, and
wherein the electronic device comprises:
a chargeable battery,
a second communication unit that receives power and performs transmission/reception of information in a non-contact manner,
a transmission unit for transmitting information indicating a size of the electronic device to the power supply apparatus via the second communication unit, and
a charging unit for charging the battery with power that is supplied from the power supply apparatus.
